(19) United States
(12) Patent Application Publication
(10) Pub. No.: US 2026/0311422 A1
(43) Pub. Date: Oct. 8, 2026

(54) EXTRACTING PHYSICALLY-BASED RENDERING (PBR) MATERIALS USING VIDEO DIFFUSION MODELS

(71) Applicant: NVIDIA Corporation, Santa Clara, CA (US)

(72) Inventors: Carl Jacob Munkberg, Malmö (SE); Jon Niklas Theodor Hasselgren, Bunkeflostrand (SE); Zian Wang, Toronto (CA); Tianchang Shen, Toronto (CA); Ruofan Liang, Toronto (CA)

(21) Appl. No.: 19/333,549

(22) Filed: Sep. 19, 2025

Related U.S. Application Data
(60) Provisional application No. 63/785,317, filed on Apr. 8, 2025.

(51) Int. Cl. G06T 15/50; G06T 13/20; G06T 15/04; G06T 15/20; G06T 17/20

(52) U.S. Cl. CPC G06T 15/506; G06T 13/20; G06T 15/04; G06T 15/20; G06T 17/20

(57) ABSTRACT

Systems and methods are disclosed that extracting material information using one or more video diffusion models. For example, embodiments of the present disclosure may process one or more images and a text prompt using a first video diffusion model to generate a rendered video of an object. For instance, the one or more images may be based on a three-dimensional (3D) geometry of the object and lighting conditions and the rendered image may include frames that show different viewpoints of the object. Subsequently, a differentiable renderer may be used to process the rendered video to generate a material data structure for the object, which indicates material information for points from the 3D geometry of the object. The material information may indicate physical-based rendering (PBR) characteristics such as an albedo, roughness, and/or metallic characteristic of the points on the object.

### CLAIM OF PRIORITY

This application claims the benefit of U.S. Provisional Application No. 63/785,317 (Attorney Docket No. 515442) titled “EXTRACTING PHYSICALLY-BASED RENDERING (PBR) MATERIALS FROM VIDEO DIFFUSION MODELS,” filed Apr. 8, 2025, the entire contents of which is incorporated herein by reference.

### BACKGROUND

Recently, leveraging diffusion models to generate three-dimensional (3D) models from text prompts has become popular. Most approaches extract data from diffusion models through differentiable rendering, typically using neural radiance fields (NeRFs) or 3D Gaussian splats (3DGS). While results have been impressive, especially for novel view synthesis (NVS), extracting materials for physical-based rendering (PBR) remains challenging. For instance, previous diffusion model approaches may be sufficiently capable of generating images (e.g., NVS images), but extracting material information (e.g., PBR information) such as base color, roughness, and metallic parameters continues to be difficult. The material information may be useful in a variety of different applications including video game design, creating digital twins, synthetic data generation for training robots, and/or physical artificial intelligence (AI). For instance, an object may be moved from a first location to a second location with different lighting conditions than the first location. If the material information for the object is known (e.g., how reflective the object is), then the object may be rendered accurately at the second location. For example, based on moving an object from a dark room into sunlight, the object may reflect the light. However, the amount of light to be reflected off of the object may be difficult to understand unless the PBR information is known. Thus, there is a need for addressing these issues and/or other issues associated with the prior art.

### SUMMARY

Embodiments of the present disclosure relate to extracting physically-based rendering (PBR) materials using video diffusion models. For instance, systems and methods are disclosed for leverage fine-tuned video diffusion models, intrinsic decomposition of videos, and/or physically-based differentiable rendering to generate high quality materials for 3D models based on a text prompt and/or an input image. For example, a new research field of leveraging diffusion models to generate 3D models from text prompts was recently introduced. Many approaches extract data from image diffusion models through differentiable rendering, typically using NeRFs or 3DGS. While results appear impressive (e.g., for novel view synthesis) extracting materials for PBR remains challenging. For instance, the lack of view-consistency in image diffusion models typically introduces blur and washes out material details. This is particularly obvious when extracting parameters for PBR materials models that rely on consistency of specular reflections. Furthermore, multi-view optimization in a surface-based renderer that disentangles materials and lighting (e.g., a physically-based path tracer) is substantially more challenging than optimizing the volumetric approaches of NeRFs and 3DGS, which bakes lighting and material in a common appearance representation. Video diffusion models are beneficial for extracting spatially varying and specular materials. They far exceed image diffusion models in handling specular highlights and provide increased view consistency. This greatly helps when extracting material parameters and for temporally consistent intrinsic decomposition.

In contrast to conventional systems, such as those described above, embodiments of the present disclosure present a method and system for text-to-material extraction based on video diffusion models. The method may begin from a known 3D geometry and a text prompt describing the desired material. A diffusion model may be conditioned on geometry buffer (Gbuffer) guides (e.g., normal and/or uniform shading), which may be extended to the video domain. By fine-tuning a diffusion model (e.g., the COSMOS World Foundation Model that is described in further detail in “NVIDIA: Cosmos world foundation model platform for physical ai” in arXiv preprint arXiv: 2501.03575 (2025), which is incorporated herein by reference) with these conditions, embodiments of the present disclosure generate video sequences of known 3D objects with synthesized materials and controlled lighting.

Then, in some examples, embodiments of the present disclosure may apply the inverse rendering pipeline of a diffusion renderer to extract material information (e.g., albedo, roughness, and metallic material maps) from the generated video. The diffusion renderer may be the diffusion renderer described in “DiffusionRenderer: Neural Inverse and Forward Rendering with Video Diffusion Models” in arXiv: 2501.018590 (2025) (hereinafter “Liang”), which is incorporated herein by reference. Additionally, and/or alternatively, the material information may be baked to texture maps through a multi-view optimization using a differentiable renderer (e.g., a differentiable path tracer) regularized on the guides extracted by the diffusion renderer. This will be described in further detail below.

In an embodiment, a computer-implemented method for extracting material information using one or more video diffusion models is provided. The method includes processing one or more images and a text prompt using a first video diffusion model, of the one or more video diffusion models, to generate a rendered video of an object. The one or more images are based on a three-dimensional (3D) geometry of the object and one or more lighting conditions images and the rendered video comprises a plurality of frames that show different viewpoints of the object. The method further comprises processing the rendered video of the object using a differentiable renderer to generate a material data structure for the object. The material data structure indicates the material information for one or more points from the 3D geometry.

### BRIEF DESCRIPTION OF THE DRAWINGS

The present systems and methods for extracting PBR materials using video diffusion models are described in detail below with reference to the attached drawing figures, wherein:

FIG. 1 shows an example of using an extraction method to extract material information, in accordance with one or more embodiments of the present disclosure.

FIGS. 2A-2C show environments for performing the extraction method of FIG. 1, in accordance with one or more embodiments of the present disclosure.

FIG. 3 illustrates a flowchart of a method for extracting material information using one or more video diffusion models, in accordance with one or more embodiments of the present disclosure.

FIG. 4 is a conceptual diagram of a processing system implemented using a PPU, suitable for use in implementing one or more embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment of the present disclosure.

FIG. 6 illustrates an exemplary streaming system suitable for use in implementing one or more embodiments of the present disclosure.

### DETAILED DESCRIPTION

Systems and methods are disclosed herein that relate to extracting PBR materials using video diffusion models, and in particular, to video diffusion models and/or differentiable renderers that address the problem of extracting material information for use in a variety of applications. For instance, embodiments of the present disclosure leverage fine-tuned video diffusion models, intrinsic decomposition of videos, and/or physically-based differentiable rendering to generate high quality materials for 3D models given a text prompt and/or a single image. Embodiments of the present disclosure may condition a video diffusion model to respect the input geometry and lighting condition. This model may produce multiple views of a given 3D model with coherent material properties. Secondly, embodiments of the present disclosure use a recent model to extract intrinsics (base color, roughness, metallic) from the generated video. Additionally, and/or alternatively, embodiments of the present disclosure use the intrinsics alongside the generated video in a differentiable renderer to robustly extract material information (e.g., PBR materials) directly compatible with common content creation tools.

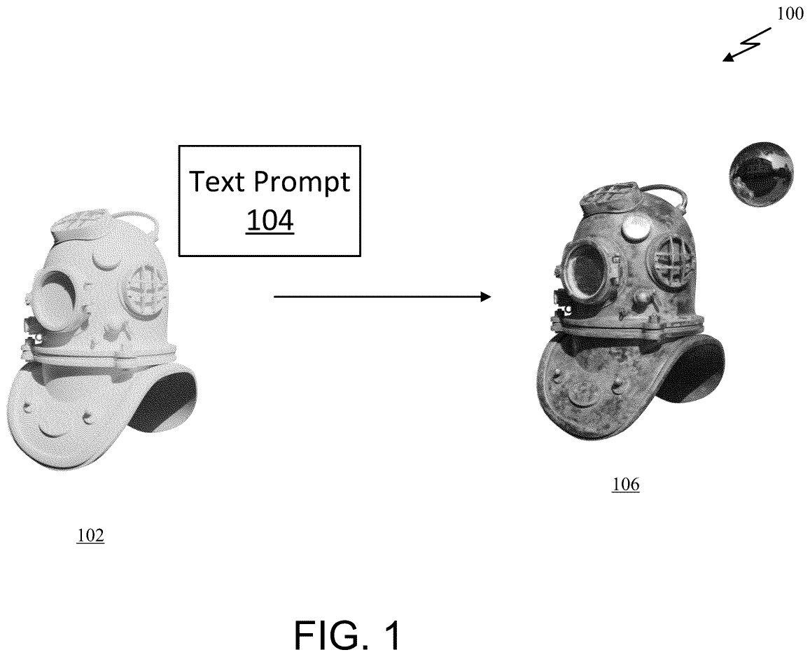

FIG. 1 shows an example of using an extraction method 100 to extract material information, in accordance with one or more embodiments of the present disclosure. The extraction method 100 may use a computing process that may be performed using any combination of hardware, firmware, and/or software. For instance, various functions may be carried out by a processor executing instructions stored in memory. The extraction method 100 may also be embodied as computer-usable instructions stored on computer storage media. The extraction method 100 may be provided by a standalone application, a service or hosted service (standalone or in combination with another hosted service), or a plug-in to another product, to name a few. In addition, extraction method 100 is described, by way of example, with respect to any one system, or any combination of systems, including, but not limited to, those described herein. Furthermore, persons of ordinary skill in the art will understand that any system that performs the extraction method 100 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

For instance, based on a 3D model and a prompt, the extraction method 100 (e.g., a VideoMat method that is used to extract PBR materials from video diffusion models) may extract high quality PBR materials from fine-tuned video diffusion models. Based on using the extraction method 100, embodiments of the present disclosure may produce spatially varying, detailed materials that may be robust to varying lighting conditions. In comparison to related approaches, embodiments of the present disclosure show higher quality results and/or improved separation of lighting and materials.

For instance, based on an input 102 (e.g., a 3D mesh) and a text prompt 104, the extraction method 100 may generate an output 106. The output 106 may indicate the material information (e.g., PBR characteristics and/or parameters) associated with input 102 (e.g., the 3D mesh). For example, the 3D mesh 102 may define the shape of a 3D object and the text prompt 104 may indicate material properties for the 3D mesh. For instance, the text prompt 104 may state that the 3D mesh 102 is “an aged diving helmet with copper-brown patina and corrosion marks that features a circular glass window, side-mounted lamp, and top valve. The weathered metal shows signs of exposure, while a leather chin strap completes the historical piece.” Based on the 3D mesh 102 and the text prompt 104, the output 106 may be generated that indicate the material information associated with the 3D mesh.

For instance, as will be described in further detail below, the extraction method 100 may use one or more video models (e.g., a pipeline/environment with only one video model, two video models, and/or additional video models) that are combined with a differentiable renderer to extract material information (e.g., PBR material textures). For instance, the extraction method 100 may obtain a given 3D model with a unique texture parametrization and a lighting condition specified by an HDR light probe. First, a video model may generate frames for a 360° orbit of an object, conditioned on geometry and lighting. Next, embodiments of the present disclosure may run multi-view reconstruction from the generated views using differentiable rendering to extract the material maps. To regularize the reconstruction process, a second video model may be used to leverage image intrinsics extracted from the generated video.

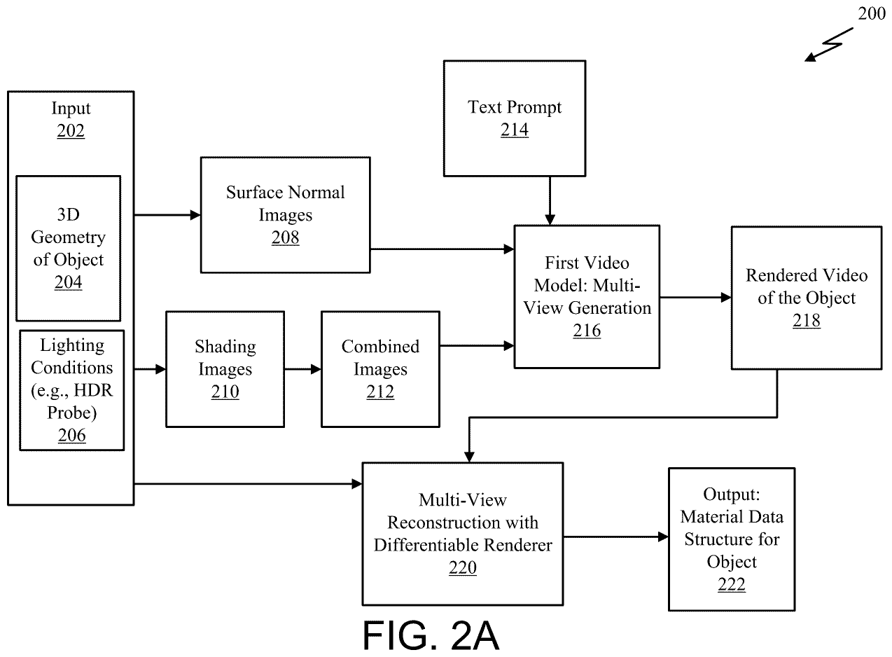

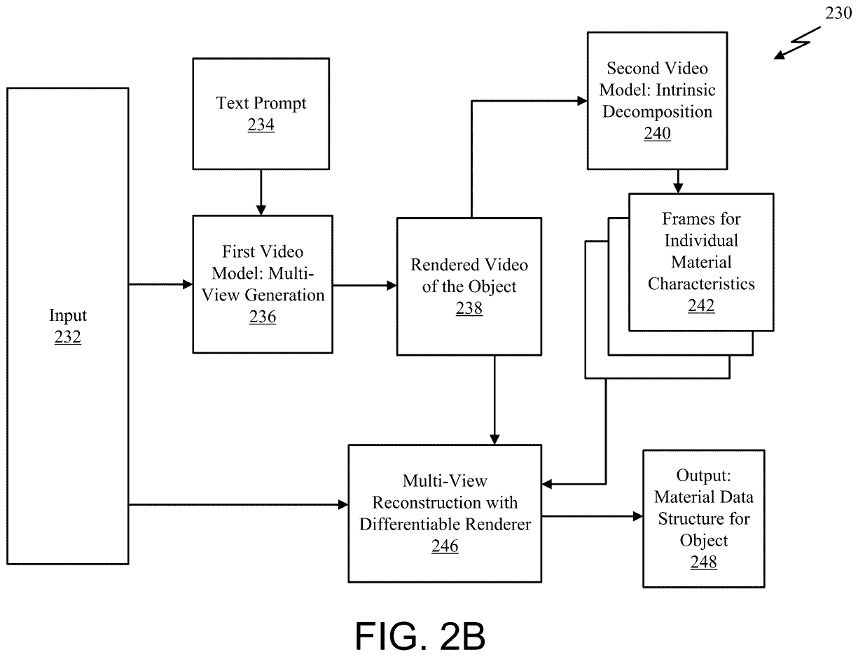

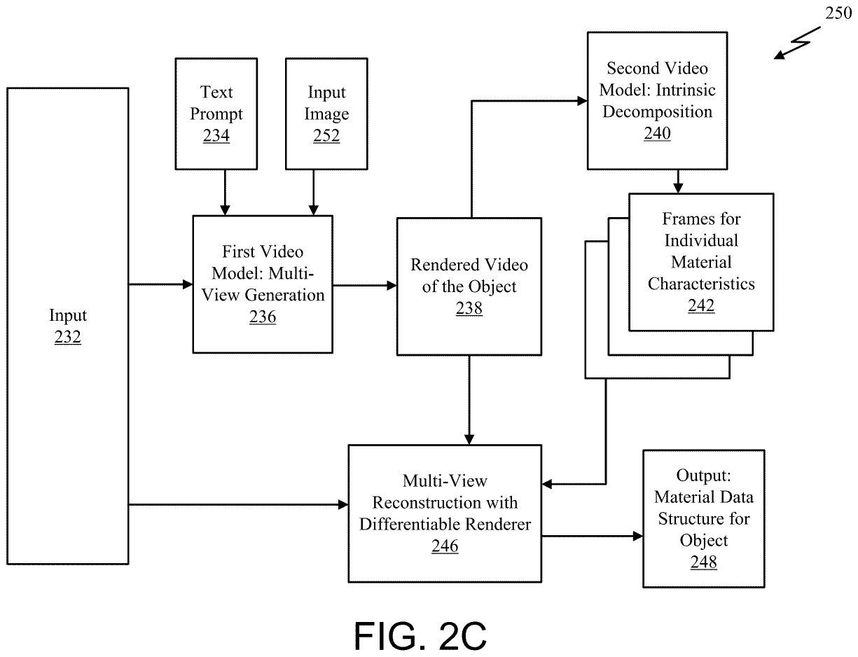

In other words, embodiments of the present disclosure may begin by obtaining a known 3D model and an HDR environment map. First, embodiments of the present disclosure may render videos of normal maps and three simple uniform shading conditions (diffuse, semi-specular, fully specular) lit with the provided probe. Next, these conditions, together with a text prompt, may be passed to a fine-tuned video model, which may generate a coherent video of the object with a novel material, while respecting the given lighting condition. Following, in embodiments using two video models, embodiments of the present disclosure may then pass this video into a second video model, which performs intrinsic decomposition, and generate per-frame GBuffers for the material properties. This step may be optional, which will be described below. In addition, the output from the two video models, alongside the given geometry and lighting are passed to a differentiable renderer (e.g., a differentiable path tracer), which performs multi-view reconstruction to extract high quality PBR materials from the generated views. The extraction method 100 will be described in further detail in FIGS. 2A-2C.

For example, FIGS. 2A-2C show environments for performing the extraction method of FIG. 1, in accordance with one or more embodiments of the present disclosure. It should be understood that the arrangements of FIGS. 2A-2C and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the environments of FIGS. 2A-2C are within the scope and spirit of embodiments of the present disclosure.

FIG. 2A shows an environment 200 for performing the extraction method 100. For instance, the input 202 may include the 3D geometry 204 of an object (e.g., the 3D mesh 102 shown in FIG. 1) and lighting conditions 206 (e.g., a high dynamic range (HDR) probe). In some instances, the lighting conditions 206 may be, include, and/or indicate one or more images indicating lighting conditions for each of the pixels. For instance, in some examples, the lighting conditions 206 may be one or more images, and each of the pixels of the image may indicate a floating point number representing an amount of light for the pixel. In some examples, the lighting conditions 206 may be an HDR probe. For example, when used for lighting a 3D scene, an HDR probe may be queried with a direction (e.g., a normalized vector). This direction may be mapped to a pixel in the HDR probe, and the pixel color and intensity may represent the lighting for that particular direction. In some instances, the lighting conditions 206 may be a lighting rig specified by a collection of point or area light sources and corresponding intensities.

Based on the input 202 (e.g., the 3D geometry 204 and the lighting conditions 206), surface normal images 208 and shading images 210 may be generated. The surface normal images 208 may be a guide image that may be based upon the geometry and may indicate a shape of the object. For instance, the surface normal image 208 may be generated based solely on the 3D geometry 204 of the object. Further, one or more shading images 210 may be generated based on varying one or more shading conditions. For instance, based on using three shading conditions/parameters (e.g., PBR characteristics indicating a base color or albedo parameter, a roughness parameter, and a metallic parameter), one or more shading images 210 may be generated (e.g., three shading images 210 may be generated). For instance, in an example, the base color k_{d} for all of the shading images 210 may be set to a uniform base color (e.g., k_{d}=(0.7, 0.7, 0.7), but the roughness parameter (r) and metallic parameter (m) may be varied. For instance, the first shading image 210 may have the roughness parameter equal to 1 and the metallic parameter equal to 0, the second shading image 210 may have the roughness parameter equal to 0.5 and the metallic parameter equal to 0.5, the third shading image 210 may have the roughness parameter equal to 0 and the metallic parameter equal to 1. As such, the shading images 210 may include a first shading image that is diffuse, a second shading image that is semi-specular, and a third shading image that is fully specular. Then, the one or more shading images 210 may be combined together to obtain combined images 212, which may be a red, green, blue (RGB) image.

The text prompt 214 (e.g., the text prompt 104 described in FIG. 1), the surface normal images 208, and the combined images 212 may be provided to the first video model 216, which may be a multi-view generation video model. The first video model 216 may process the text prompt 214, the surface normal images 208, and the combined images 212 to generate a rendered video 218 (e.g., a generated video and/or a synthetized video) of the object. For example, the rendered video 218 of the object may include a plurality of frames (e.g., 121 frames) that indicate a 360-degree view of the object. For instance, the object may be a soccer ball. Each frame of the rendered video 218 may show a different viewpoint of the soccer ball such that the rendered video 218 moves the viewpoint in a clockwise or counterclockwise rotation to show different viewpoints of the soccer ball. In some examples, the first video model 216 may be a video diffusion model such as the COSMOS World Foundation Model. In some instances, the number of surface normal images 208 used may correspond to the number of frames of the rendered video 218 (e.g., 121 surface normal images 208 may be used when the rendered video includes 121 frames).

In some instances, prior to using the first video model 216, the first video model 216 may be fine-tuned. For instance, the first video model 216 may be further trained and/or adapted to accept the inputs described above (e.g., the text prompt 214, the surface normal images 208, and the combined images 212) and generate the rendered video 218 showing the 360-degree view of the object. For example, using a dataset comprising a plurality of videos of object-center 360° orbits of 3D models, surface normal images, shading images/combined images (e.g., the combined RGB image), and/or text prompts may be obtained. Subsequently, the first video model 216 may process the surface normal images, combined images, and/or text prompts to generate rendered videos. The rendered videos may be compared to the videos from the dataset to determine a loss based on using a loss function (e.g., the loss function from the COSMOS World Foundation Model), and the parameters of the first video model 216 may be further updated and/or fine-tuned based on the determined loss. As such, based on fine-tuning the first video model 216, the first video model 216 may be incentivized to generate higher quality rendered videos showing 360-degree view of the object.

In other words, in a first step, embodiments of the present disclosure generate videos of a 360° camera revolution around the 3D model, based on a text prompt 214 describing the object's material. Embodiments of the present disclosure may fine-tune a first video model 216 such as a Diffusion Transformer (DiT) video model with additional conditions to respect the lighting and input geometry. For instance, the first video model 216 may operate in a latent space with compression in the spatial and temporal domain. Encoding and decoding to and from latent space may be performed by a pre-trained variational autoencoder (VAE). The first video model 216 may support text and image guided video generation at a certain resolution and/or frames (e.g., a resolution of 1280×704 pixels and 121 frames).

Embodiments of the present disclosure may condition the first video model 216 with intrinsic guides (e.g., normals in camera space such as the surface normal images 208 and a simple shading guide that provides scene lighting information such as the shading images 210 and/or combined images 212). The shading guide (e.g., the combined images 212) may be rendered using three shading images 210. The three shading images 210 may be based on three uniform materials with constant albedo, k_{d}=0.7, roughness, r={1,0.5,0} and metallic, m= {0,0.5,1}. The combined images 212 may be generated based on compressing the three shading images 210 into a single RGB-image by encoding the luminance of each image as a separate channel and provide these conditions per-frame.

In some instances, embodiments of the present disclosure may increase the input feature count of the input embedding layer of the first video model 216 to account for additional inputs (e.g., surface normal images 208 and the combined images 212), encoded into latent space using a frozen tokenizer (e.g., the frozen tokenizer of the COSMOS World Foundation Model). For instance, the tokenizer may be pre-trained and the weights of the tokenizer may be frozen as they are not further updated. Embodiments of the present disclosure may concatenate the encoded features with the noisy video in latent space along the channel dimension, and fine-tune the embedding layer and all DiT layers using a custom dataset for a certain number of iterations (e.g., 10,000 iterations) using one or more graphics processing units (GPUs) (e.g., 64 GPUs). Embodiments of the present disclosure may use a denoising score matching loss such as the unmodified version of the denoising score matching loss from the COSMOS World Foundation model.

In some examples, the dataset used to fine-tune the first video model 216 may include a large collection of videos of object-centric 360° orbits of 3D models from one or more datasets. For each object, embodiments of the present disclosure may render a video with 121 frames at a resolution of 1280×704 using a path tracer with three bounces. For lighting, embodiments of the present disclosure use a randomly selected probe from a number of HDR maps from a database. Embodiments of the present disclosure may also render the intrinsic normal and simple shading guides. Video captions may be automatically generated using one or more models. Since the generated videos (e.g., the rendered video 218) are cyclical, embodiments of the present disclosure may augment the dataset by randomly reversing the video, and randomly offsetting the video start frame on each training iteration.

The multi-view reconstruction with differentiable renderer 220 (e.g., a differentiable path tracer) may be used to determine the material information (e.g., the PBR characteristics) based on the rendered video 218 of the object and the inputs 202. For instance, the differentiable renderer 220 (e.g., a differentiable renderer) may process the 3D geometry 204 of the object, the lighting conditions 206 (e.g., the HDR probe), and the rendered video 218 of the object (e.g., the 121 frames that are rendered by the first video model 216) to generate an output 222 indicating the material information associated with the 3D geometry 204. For instance, the output 222 may be and/or include a material data structure for the object, and the material data structure may indicate the material information such as the PBR characteristics for the object from the 3D geometry 204 and/or surface normal texture maps, images, and/or other surface texture indications for the object. For example, as mentioned previously, the PBR characteristics may include a base color/albedo characteristic, a roughness characteristic, and a metallic characteristic. The base color/albedo characteristic may indicate the texture detail (e.g., the reflective/diffused color without highlights/shading). The roughness characteristic may indicate how polished the object is at each position. The metallic characteristic may indicate which part of the object is metallic and which part of the object is not metallic (e.g., is made from wood). The above PBR characteristics are merely exemplary and the material data structure may include additional and/or alternative PBR characteristics.

Additionally, and/or alternatively, the output 222 may be, indicate, and/or be associated with an image that simulates the appearance of surface detail and/or texture of the object such as bumps, scratches, wrinkles, and more. In other words, based on the output 222, an image may be generated that includes the surface normal texture of the object (e.g., an image such as a surface normal texture map that shows the bumps, scratches, wrinkles, and/or other surface texture of the object). The above material information is merely exemplary and the output 222 may include additional and/or alternative material information associated with the object.

In some instances, the material data structure may include entries that correspond to the 3D geometry 204. For instance, each point within the 3D geometry 204 may have a corresponding entry within the material data structure, and the entry may indicate the material information (e.g., the PBR characteristics) for the corresponding point. For example, based on the output 222, the PBR characteristics for each point of the 3D geometry 204 may be known. Thus, by moving the object to a different environment or location (e.g., with different lighting conditions), the object may be rendered more easily and accurately.

In other words, to extract material information (e.g., the output 222) from the generated videos (e.g., the rendered videos 218), embodiments of the present disclosure run multi-view reconstruction with a differentiable renderer 220. For instance, the differentiable renderer 220 may be and/or include any type of differentiable renderer, but may include added support for querying a hash grid and/or multilayer perceptron (MLP) representation inline in the ray tracing loop. Embodiments of the present disclosure may leverage this representation as a multi-scale material representation, which may be more robust in optimization than two-dimensional (2D) texture maps. After optimization, embodiments of the present disclosure may sample out the hash grid into standard 2D texture maps.

In some examples, the differentiable renderer 220 (e.g., the differentiable renderer) may take a 3D model (e.g., the 3D geometry 204) and the HDR probe (e.g., the lighting conditions 206), alongside camera poses and/or frames from the rendered video 218 from the first video model 216 to generate the output 222. Additionally, and/or alternatively, as will be described in further detail below, the differentiable renderer 220 may further take intrinsic information from a second video model (e.g., a second video model 240 that will be described in further detail in FIG. 2B), and use this information to generate the output 222. In some instances, embodiments of the present disclosure may run multi-view reconstruction to optimize the material maps for 1,000 iterations using one or more parameters (e.g., parameters associated with the batch size, bounces, and/or the forward/backward pass).

The shading of the model is described below. For instance, embodiments of the present disclosure may have a goal for all-frequency lighting including shadows, reflections, and indirect illumination. The outgoing radiance L(ωₒ) in direction ωₒ may be expressed using the rendering equation:

$$L ( {ω}_{o} ) = {\int }_{Ω} {L}_{i} ( {ω}_{i} ) f ( {ω}_{i} , {ω}_{o} ) ( {ω}_{i} \cdot n ) d {ω}_{i} \qquad ( 1 )$$

This is an integral of the product of the incident radiance, Lᵢ(ωᵢ) from direction ωᵢ and the bidirectional scattering distribution function (BSDF) ƒ(ωᵢ, ωₒ). The integration domain may be the hemisphere 22 around the surface intersection normal, n.

Embodiments of the present disclosure may use a PBR material model that combines a Lambertian term and a Cook Torrance microfacet specular shading model:

$$f ( {ω}_{i} , {ω}_{o} ) = \frac{DGF}{4 ( {ω}_{o} \cdot n ) ( {ω}_{i} \cdot n )} \qquad ( 2 )$$

where D, G and F are functions representing the ground glass unknown (GGX) normal distribution (NDF), geometric attenuation, and Fresnel term, respectively. This BSDF may be parameterized with an RGB base color, C_{base}, and scalar roughness, r, and metallic, m, values at each shading point. The specular lobe may be described by the roughness value for the GGX normal distribution function, D. The diffuse albedo may be given by

$${k}_{d} = {c}_{base} \cdot ( 1 - m ) ,$$

and specular albedo

$${k}_{s} = 0.04 \cdot ( 1 - m ) + {c}_{base} \cdot m .$$

The rendering equation may be evaluated using Monte Carlo integration, and embodiments of the present disclosure may apply multiple importance sampling, to reduce variance. Embodiments of the present disclosure may use three sampling techniques: light importance sampling, cosine sampling for the diffuse lobe, and GGX importance sampling for the specular lobe.

FIG. 2B shows another environment 230 for performing the extraction method 100. For instance, the environment 230 may include many of the same components, entities, and/or functionalities of environment 200 described above except that environment 230 further includes a second video model 240. For instance, the input 232 may include the 3D geometry 204 and the lighting conditions 206. In addition, the input 232 may further include the surface normal images 208, the shading images 210, and the combined images 212 (e.g., the surface normal images 208, the shading images 210, and the combined images 212 that are determined from the 3D geometry 204 and the lighting conditions 206). The input 232 (e.g., the surface normal images 208, the shading images 210, and the combined images 212) and the text prompt 234 (e.g., the text prompt 214) may be processed by the first video model 236 (e.g., the first video model 216) to generate a rendered video 238 of the object (e.g., a 360-degree view of the object).

The rendered video 238 may be provided the multi-view reconstruction with differentiable renderer 246 (e.g., differentiable path tracer) as described above in FIG. 2A, but in FIG. 2B, the rendered video 238 may further be provided to the second video model 240, which may be used for intrinsic decomposition. For example, the second video model 240 may be a video diffusion model such as the COSMOS World Foundation Model described above. In some instances, the second video model 240 may also be fine-tuned. As such, in some variations, the second video model 240 may be an inverse renderer video diffusion model that estimates material attributes conditioned on the input video (e.g., the rendered video 238). For instance, the rendered video 238 may include a plurality of frames such as 121 frames. The second video model 240 may process the frames of the rendered video 238 and generate frames 242 for individual material characteristics (e.g., the individual material characteristic frames) from the material information. For example, as mentioned above, the material information may be and/or include PBR characteristics such as base color characteristics, roughness characteristics, and metallic characteristics. The second video model 240 may process the frames of the rendered video 238 and generate a first set of frames for the first material characteristic (e.g., 121 frames for the base color characteristic), a second set of frames for the second material characteristic (e.g., 121 frames for the roughness characteristic), a third set of frames for the third material characteristic (e.g., 121 frames for the metallic characteristic), and so on. The frames 242 for the individual material characteristic may include the first, second, and third set of frames for the different material characteristics.

Subsequently, the frames 242 may also be provided to the multi-view reconstruction with differentiable renderer 246. The multi-view reconstruction with differentiable renderer 246 may process the frames 242 along with the rendered video 238 for the object to generate the output 248, which may indicate the material data structure for the object. To put it another way, in FIG. 2B, the second video model 240 may generate a set of frames for each characteristic from the material data structure 248. For instance, in the example that the material data structure 248 is associated with the three PBR characteristics described above, the second video model 240 may generate the three sets of frames described above.

In other words, in some examples, to extract intrinsic channels-base color, roughness, and metallic maps from the generated video (e.g., the rendered video 238), embodiments of the present disclosure may implement (e.g., re-implement) and/or use an inverse renderer (e.g., the second video model 240 may be a diffusion renderer). The second video model 240 (e.g., the inverse renderer) may be a video diffusion model that estimates material attributes conditioned on the input video (e.g., the rendered video 238). The same model (e.g., the second video model 240) may be used to generate all material attributes. For instance, the second video model 240 may generate one material map at a time, and may use optimizable domain embeddings to specify the target attributes to generate.

In some instances, the second video model 240 may be a fine-tuned inverse rendering model from the COSMOS World Foundation Model, which may provide high quality results. The second video model 240 may be fine-tuned using 150,000 videos with objects from a database. In some examples, the second video model 240 may be a Diffusion Renderer such as the Diffusion Renderer that is described in Liang.

In some instances, the multi-view reconstruction with the differentiable renderer 246 may use one or more objective functions based on the rendered video 238 and the frames 242 for the individual material characteristics. For instance, these objective functions may be combined by using one or more weights and/or may use more elaborate uncertainty-based and/or adaptive weighting schemes such as a Kendall loss that is described in further detail in “Multi-Task Learning Using Uncertainty to Weigh Losses for Scene Geometry and Semantics” in arXiv: 1705.07115 (2017), which is incorporated herein by reference.

In some examples, the entities within environments 200 and/or 230 may include multiple training stages. For example, as mentioned above, prior to using the first video model 216, the first video model 216 may be fine-tuned. The fine-tuning of the first video model 216 may involve comparing the rendered videos that are output from the first video model 216 with a reference video (e.g., videos from the dataset) using a standard loss function to determine the loss. As such, the first video model 216 may be trained on 360 orbits (e.g., 360-degree view of the object).

Subsequent to performing the fine-tuning of the first video model 216, a second training stage may be performed using a total loss function, and the second stage may involve performing multi-view optimization with differentiable rendering. For instance, the fine-tuned first video model 216 may be leveraged to generate multiple views of the object with materials. These views may be used in a multi-view optimization task using the differentiable renderer 220 (e.g., the differentiable renderer), where the goal may be to find a common material representation in the texture space for a 3D object such that it looks as close as possible when rendered to the same camera views as was generated from the first video model 216. In this stage, two loss terms may be used: 1) a first loss term may be computed for each rendered view based on comparing the rendered view with the corresponding generated view from the first video model 216; and 2) a second loss term may be computed based on comparing the rendered material maps (e.g., base color, roughness, metalness) for each view with the corresponding view from the second video model (e.g., the second video model 240).

In other words, the total loss may be described by an optimization task. For instance, ¢ may denote the optimization parameters (e.g., the spatially varying material maps). For a given camera pose, c, the differentiable renderer (e.g., the differentiable renderer 246) may produce an image I_{φ}(c). The reference image I_{ref}(c) may be a view from the same camera, generated by the first video model 236. Given a loss function L, embodiments of the present disclosure may minimize the empirical risk:

$${argmin}_{ϕ} {𝔼}_{c} [ L ( {I}_{ϕ} ( c ) , {I}_{ref} ( c ) ) ] \qquad ( 3 )$$

using Adaptive Moment Estimation (ADAM) based on gradients with respect to the optimization parameters, σ_{L}/σ_{φ}.

The image loss, L_{image}, may be an L₁ norm on tonemapped and gamma corrected standard RGB (sRGB) colors. This may be combined with a scale invariant regularizer loss, L_{reg}:

$${L}_{reg} = {L}_{1} ( \frac{x}{\overline{x}} , \frac{y}{\overline{y}} ) \qquad ( 4 )$$

applied to each of the predicted intrinsics (e.g., base color, roughness, metallic) from the second video model 240, where each image may be divided by its mean value before computing the L₁ loss. For instance, variable x may represent the predicted intrinsic and y may represent the reference intrinsic. Further, x and y may represent the mean of x and y, respectively.

In some examples, the regularizer loss L_{reg} may be applied to each intrinsic term and thus in some instances, the regularizer loss may be a sum of three regularizer loss terms (e.g., one for each of base color, roughness, and metallic). The sum of the three regularizer loss terms L_{regtotal} may be shown in the below expression:

$${L}_{regtotal} = {L}_{reg ( base color )} + {L}_{reg ( roughness )} + {L}_{reg ( metallic )} .$$

where each of L_{reg(base color)}, L_{reg(roughness)}, and L_{reg(metallic)} may be based on expression 4 above (e.g., for L_{reg(base color)}, x may indicate the predicted base color and y may indicate the reference base color).

In some examples, the scale invariant formulation may be more robust against biases in the predicted intrinsics. In some instances, all loss terms may be masked, applied only to pixels covered by the object.

As such, the total loss function may be:

$$L = {L}_{image} + λ {L}_{reg}$$

In some instances, embodiments of the present disclosure may use a parameter Δ=0.2 for all three regularizer terms.

In some instances, in addition to or as an alternative to processing the text prompts (e.g., the text prompts 104, 214, and/or 234), the first video model 236 may further obtain and process an input image. For instance, FIG. 2C shows another environment 250 for performing the extraction method 100.

The environment 250 may include similar components to the environment 230 from FIG. 2B except that an input image 252 is further processed by the first video model 236 to generate the rendered video 238 of the object. For instance, the input image 252 may be an image of the object and may show the desired material information to be output from the multi-view reconstruction with differentiable renderer 246. For example, the first video model 236 may be conditioned on the input image 252, which may be warped (e.g., using a provided depth buffer) according to the camera trajectory. This may enable a more accurate and/or desired output 248 from the differentiable renderer 246.

In some examples, the input image 252 may be processed by the first video model 216 from environment 200 of FIG. 2A. In other words, the second video model 240 and the frames 242 may be optional. When not included, the first video model 216 may process the input image 252 as well as the other inputs from FIG. 2A to generate the rendered video 218. The differentiable renderer 220 may process the rendered video 218 to generate the output 222.

In some variations, the material data structure (e.g., the outputs 222 and/or 248) for the object that indicates the material information may be used for one or more use cases. For instance, the material data structure may be used for artist friendly workflows (e.g., to create and enhance materials from text or images) and/or for large scale 3D datasets (e.g., enhancing the material quality for automatic material augmentation).

In other words, the environment 250 (e.g., the pipeline shown by environment 250) may also accommodate material generation from an image example. For instance, the first diffusion model 236 may be the COSMOS World Foundation Model, which may inherently support both text and image conditioning. For this, embodiments of the present disclosure may use an approach described in “GEN3C: 3D-Informed World-Consistent Video Generation with Precise Camera Control” in arXiv: 2503.03751 (2025), which is incorporated herein by reference. For instance, this approach may utilize the video model (e.g., the first video model 236) being conditioned on an input image (e.g., the input image 252), which is warped (using a provided depth buffer) according to the camera trajectory. As in the text-to-video environments described above, the first video model 236 may be conditioned on normal (e.g., the surface normal images 208) and three shading conditions (e.g., the shading images 210 that may be combined to the combined images 212). In some instances, the first video model 236 may increase the input feature count of the input embedding layer of the diffusion model to account for our additional inputs (e.g., warped images, normals, and/or simple shadings), and the first video model 236 may be fine-tuned using a custom dataset.

Among other benefits and advantages, embodiments of the present disclosure provide an extraction method 100 for extracting material information (e.g., PBR characteristics) for an object based on using a first video model 216 (e.g., a first video diffusion model). The first video model 216 may process the surface normal images 208, a text prompt 214, and combined images 212 to generate a rendered video 218 of the object. A material data structure 222 indicating the material information may be generated based on a differentiable renderer 220 processing the rendered video 218. Additionally, and/or alternatively, in some embodiments, a second video model 240 may be used to generate frames 242 for individual material characteristics based on the rendered video 238 output from the first video model 236. The frames 242 may be used as an additional input to the differentiable renderer 246 to generate the material data structure 248. Additionally, and/or alternatively, a first video model 236 may further accept an input image 252 as an input, and the extraction method 100 may use the input image 252 for determining the material data structure 248 indicating the material information for the object.

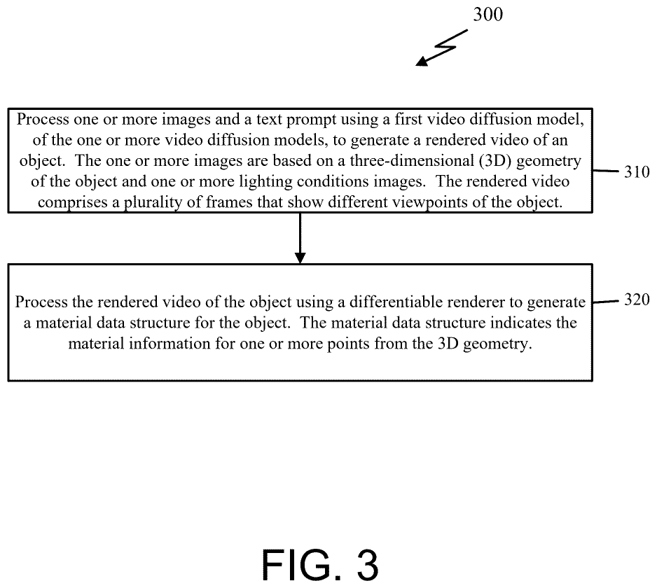

FIG. 3 illustrates a flowchart of a method 300 for extracting material information using one or more video diffusion models. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the diffusion models and/or the differentiable renderer (e.g., a differentiable renderer) described above in FIGS. 1 and 2A-2C. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, one or more images and text prompt are processed using a first video diffusion model of the one or more video diffusion models to generate a rendered video of an object. The one or more images are based on a three-dimensional (3D) geometry of the object and one or more lighting conditions images. The rendered video comprises a plurality of frames that show different viewpoints of the object. In an embodiment, the plurality of frames of the rendered video show a 360-degree view of the object.

At step 320, the rendered video of the object is processed using a differentiable renderer to generate a material data structure for the object. The material data structure indicates the material information for one or more points from the 3D geometry. In an embodiment, the material data structure comprises a plurality of entries. Each entry from the plurality of entries is associated with a point from the 3D geometry of the object (e.g., a surface point and/or a small area element on the surface of the 3D object) and indicates the material information for the point from the 3D geometry of the object. The material information comprises physical-based rendering (PBR) characteristics for the point and the PBR characteristics comprise an albedo characteristic, a roughness characteristic, and a metallic characteristic. In an embodiment, each entry within the material data structure further indicates a surface normal texture map that shows surface textures of the object indicated by the 3D geometry.

In an embodiment, the method 300 further comprises obtaining the 3D geometry of the object indicating a 3D mesh of the object comprising a plurality of points and the one or more lighting conditions images indicating a high definition range (HDR) probe and generating the one or more images based on the 3D mesh and the HDR probe. In an embodiment, generating the one or more images comprises generating surface normal images indicating a shape of the object from multiple different viewpoints; generating a plurality of shading images based on varying at least one of a plurality of shading parameters, wherein the plurality of shading parameters comprises an albedo parameter, a roughness parameter, and a metallic parameter; and combining the plurality of shading images into red, green, blue (RGB) combined images, wherein processing the one or more images and the text prompt using the first video diffusion model comprises processing the RGB combined images, the text prompt, and the surface normal images using the first diffusion model to generate the rendered video of the object.

In an embodiment, the method 300 further comprises prior to processing the one or more images and the text prompt using the first video diffusion model, performing fine-tuning of the first video diffusion model. In an embodiment, performing the fine-tuning of the first video diffusion model comprises: determining training normal images and training shading images from a training dataset comprising a plurality of training videos; processing the training normal images and the training shading images using the first video diffusion model to generate rendered videos; and based on comparing the rendered videos with the plurality of training videos from the training dataset using a loss function, fine-tuning the first video diffusion model.

In an embodiment, the method 300 further comprises: processing the generated rendered video of the object that is output from the first video diffusion model using a second video diffusion model, of the one or more video diffusion models, to generate a plurality of individual material characteristic frames, and wherein processing the rendered video of the object using the differentiable renderer to generate the material data structure for the object comprises processing the rendered video of the object and the plurality of individual material characteristic frames using the differentiable renderer to generate the material data structure. In an embodiment, the material data structure indicates a plurality of physical-based rendering (PBR) characteristics, and wherein the plurality of individual material characteristic frames comprises a set of frames for each of the plurality of PBR characteristics.

In an embodiment, the one or more images comprises surface normal images and combined images that are generated based on using the 3D geometry of the object and the one or more lighting conditions images. The method 300 further comprises: obtaining an input image of the object, wherein processing the one or more images and the text prompt using the first video diffusion model to generate the rendered video of the object comprises processing the surface normal images, the combined images, and the input image using the first video diffusion model to generate the rendered video of the object. For instance, the surface normal images may include a normal image for each frame, the combined images may include a combined shading image for each frame, and the input image may be a single input image with a corresponding depth buffer, which may then be warped to each frame by using the depth buffer and the camera matrix for each frame.

In an embodiment, at least one of steps 310 and 320 and/or the further steps described above for method 300 are performed on a server or in a data center to generate the material data structure, and the material data structure is streamed to a user device. In an embodiment, at least one of steps 310 and 320 and/or the further steps described above for method 300 is performed within a cloud computing environment. In an embodiment, at least one of steps 310 and 320 and/or the further steps described above for method 300 is performed for training, testing, or certifying a neural network employed in a machine, robot, or autonomous vehicle. In an embodiment, at least one of steps 310 and 320 and/or the further steps described above for method 300 is performed on a virtual machine comprising a portion of a graphics processing unit.

In some examples, conventional approaches such as NeRFs or 3DGS have been used successfully for NVS, but extracting materials for physical-based rendering (PBR) continues to remain challenging for these conventional approaches. As such, embodiments of the present disclosure present a method and system for text-to-material extraction based on video diffusion models. For instance, based on Gbuffer guides, text prompts, and/or an input image, a first video diffusion model may be used to generate a rendered video of the object. For instance, the first video diffusion model may be conditioned to accept Gbuffer guides such as surface normal images and combined images that are based on a 3D geometry of the object, lighting conditions, and/or shading images. A differentiable renderer (e.g., differentiable path tracer) may be used to process the rendered video from the first video diffusion model to generate material data structure for the object such as PBR characteristics of the object. In some instances, a second video model may be used that also processes the rendered video from the first video diffusion model to generate frames for the individual material characteristics. The frames for the individual material characteristics may further be used by the differentiable renderer to generate the material data structure for the object.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

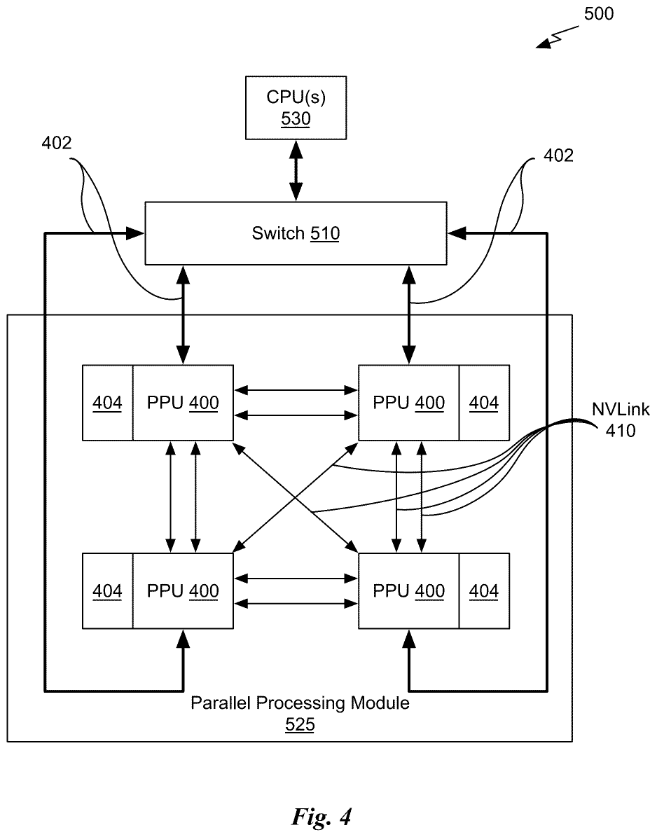

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

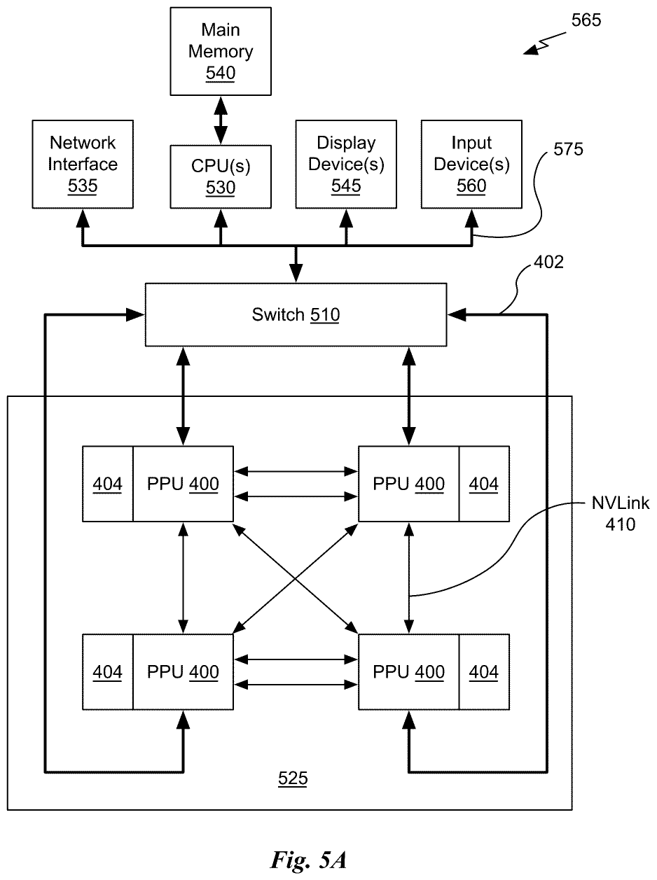

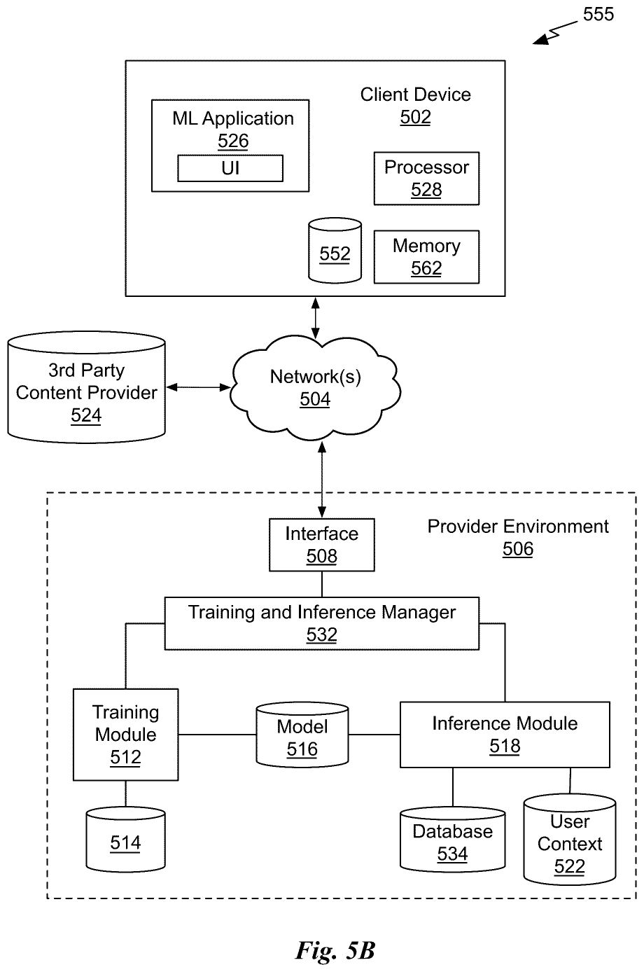

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

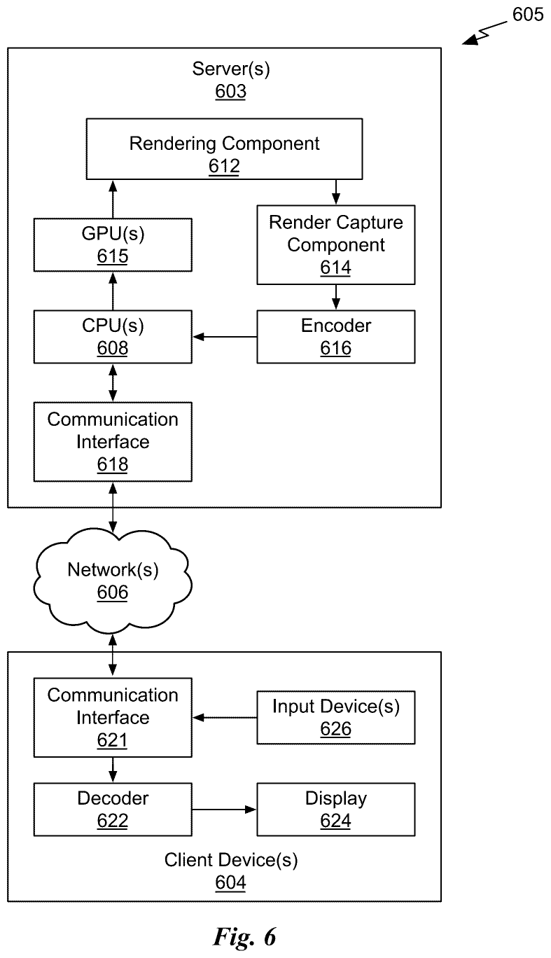

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for extracting material information using one or more video diffusion models, comprising:
processing one or more images and a text prompt using a first video diffusion model, of the one or more video diffusion models, to generate a rendered video of an object, wherein the one or more images are based on a three-dimensional (3D) geometry of the object and one or more lighting conditions images, and wherein the rendered video comprises a plurality of frames that show different viewpoints of the object; and
processing the rendered video of the object using a differentiable renderer to generate a material data structure for the object, wherein the material data structure indicates the material information for one or more points from the 3D geometry.

2. The computer-implemented method of claim 1, further comprising:
obtaining the 3D geometry of the object indicating a 3D mesh of the object comprising a plurality of points and the one or more lighting conditions images indicating a high dynamic range (HDR) probe; and
generating the one or more images based on the 3D mesh and the HDR probe.

3. The computer-implemented method of claim 2, wherein generating the one or more images comprises:
generating surface normal images indicating a shape of the object from multiple different viewpoints;
generating a plurality of shading images based on varying at least one of a plurality of shading parameters, wherein the plurality of shading parameters comprises an albedo parameter, a roughness parameter, and a metallic parameter; and
combining the plurality of shading images into red, green, blue (RGB) combined images, wherein processing the one or more images and the text prompt using the first video diffusion model comprises processing the RGB combined images, the text prompt, and the surface normal images using the first video diffusion model to generate the rendered video of the object.

4. The computer-implemented method of claim 1, wherein the plurality of frames of the rendered video show a 360-degree view of the object.

5. The computer-implemented method of claim 1, further comprising:
prior to processing the one or more images and the text prompt using the first video diffusion model, performing fine-tuning of the first video diffusion model.

6. The computer-implemented method of claim 5, wherein performing the fine-tuning of the first video diffusion model comprises:
determining training normal images and training shading images from a training dataset comprising a plurality of training videos;
processing the training normal images and the training shading images using the first video diffusion model to generate rendered videos; and
based on comparing the rendered videos with the plurality of training videos from the training dataset using a loss function, fine-tuning the first video diffusion model.

7. The computer-implemented method of claim 1, wherein the material data structure comprises a plurality of entries, and wherein each entry from the plurality of entries is associated with a point from the 3D geometry of the object and indicates the material information for the point from the 3D geometry of the object, wherein the material information comprises physical-based rendering (PBR) characteristics for the point, wherein the PBR characteristics comprise an albedo characteristic, a roughness characteristic, and a metallic characteristic.

8. The computer-implemented method of claim 7, wherein each entry within the material data structure further indicates a surface normal texture map that shows surface textures of the object indicated by the 3D geometry.

9. The computer-implemented method of claim 1, further comprising:
processing the generated rendered video of the object that is output from the first video diffusion model using a second video diffusion model, of the one or more video diffusion models, to generate a plurality of individual material characteristic frames, and
wherein processing the rendered video of the object using the differentiable renderer to generate the material data structure for the object comprises processing the rendered video of the object and the plurality of individual material characteristic frames using the differentiable renderer to generate the material data structure.

10. The computer-implemented method of claim 9, wherein the material data structure indicates a plurality of physical-based rendering (PBR) characteristics, and wherein the plurality of individual material characteristic frames comprises a set of frames for each of the plurality of PBR characteristics.

11. The computer-implemented method of claim 1, wherein the one or more images comprises surface normal images and combined images that are generated based on using the 3D geometry of the object and the one or more lighting conditions images, wherein the method further comprises:
obtaining an input image of the object, wherein processing the one or more images and the text prompt using the first video diffusion model to generate the rendered video of the object comprises processing the surface normal images, the combined images, and the input image using the first video diffusion model to generate the rendered video of the object.

12. The computer-implemented method of claim 1, wherein at least one of the steps of processing the one or more images and the text prompt using the first video diffusion model and processing the rendered video of the object using the differentiable renderer are performed on a server or in a data center to generate the material data structure, and the material data structure is streamed to a user device.

13. The computer-implemented method of claim 1, wherein at least one of the steps of processing the one or more images and the text prompt using the first video diffusion model and processing the rendered video of the object using the differentiable renderer are performed within a cloud computing environment.

14. The computer-implemented method of claim 1, wherein at least one of the steps of processing the one or more images and the text prompt using the first video diffusion model and processing the rendered video of the object using the differentiable renderer are performed for training, testing, or certifying a neural network employed in a machine, robot, or autonomous vehicle.

15. The computer-implemented method of claim 1, wherein at least one of the steps of processing the one or more images and the text prompt using the first video diffusion model and processing the rendered video of the object using the differentiable renderer are performed on a virtual machine comprising a portion of a graphics processing unit.

16. A system for extracting material information using one or more video diffusion models, comprising:
one or more processors; and
a non-transitory computer-readable medium having processor-executable instructions stored thereon, wherein the processor-executable instructions, when executed by the one or more processors, facilitate:
processing one or more images and a text prompt using a first video diffusion model, of the one or more video diffusion models, to generate a rendered video of an object, wherein the one or more images are based on a three-dimensional (3D) geometry of the object and one or more lighting conditions images, and wherein the rendered video comprises a plurality of frames that show different viewpoints of the object; and
processing the rendered video of the object using a differentiable renderer to generate a material data structure for the object, wherein the material data structure indicates the material information for one or more points from the 3D geometry.

17. The system of claim 16, wherein the processor-executable instructions, when executed by the one or more processors, further facilitate:
obtaining the 3D geometry of the object indicating a 3D mesh of the object comprising a plurality of points and the one or more lighting conditions images indicating a high dynamic range (HDR) probe; and
generating the one or more images based on the 3D mesh and the HDR probe.

18. The system of claim 17, wherein generating the one or more images comprises:
generating surface normal images indicating a shape of the object from multiple different viewpoints;
generating a plurality of shading images based on varying at least one of a plurality of shading parameters, wherein the plurality of shading parameters comprises an albedo parameter, a roughness parameter, and a metallic parameter; and
combining the plurality of shading images into red, green, blue (RGB) combined images, wherein processing the one or more images and the text prompt using the first video diffusion model comprises processing the RGB combined images, the text prompt, and the surface normal images using the first video diffusion model to generate the rendered video of the object.

19. A non-transitory computer-readable medium having processor-executable instructions stored thereon for extracting material information using one or more video diffusion models, wherein the processor-executable instructions, when executed, facilitate:
processing one or more images and a text prompt using a first video diffusion model, of the one or more video diffusion models, to generate a rendered video of an object, wherein the one or more images are based on a three-dimensional (3D) geometry of the object and one or more lighting conditions images, and wherein the rendered video comprises a plurality of frames that show different viewpoints of the object; and
processing the rendered video of the object using a differentiable renderer to generate a material data structure for the object, wherein the material data structure indicates the material information for one or more points from the 3D geometry.

20. The non-transitory computer-readable medium of claim 19, wherein the processor-executable instructions, when executed, further facilitate:
obtaining the 3D geometry of the object indicating a 3D mesh of the object comprising a plurality of points and the one or more lighting conditions images indicating a high dynamic range (HDR) probe; and
generating the one or more images based on the 3D mesh and the HDR probe.
